(19) United States
(12) Patent Application Publication
(10) Pub. No.: US 2026/0351634 A1
(43) Pub. Date: Nov. 5, 2026

(54) PLATE OF A CELL STACK, AND METHOD FOR MOUNTING A SEAL ON A PLATE

(71) Applicant: Schaeffler Technologies AG & Co. KG, Herzogenaurach (DE)

(72) Inventors: Sander Ten Hoopen, Noordwijkerhout (NL); Frank Meyer-Pittroff, Hessdorf (DE)

(73) Assignee: Schaeffler Technologies AG & Co. KG, Herzogenaurach (DE)

(21) Appl. No.: 19/100,197

(22) PCT Filed: Jul. 17, 2023
(86) PCT No.: PCT/DE2023/100523

§ 371 Date: Jan. 31, 2025

(30) Foreign Application Priority Data
Aug. 1, 2022 (DE) 102022119198.2

(51) Int. Cl. H01M 8/0276; C25B 9/75

(52) U.S. Cl. CPC H01M 8/0278; C25B 9/75

(57) ABSTRACT

A plate of a stack of electrochemical cells, in particular an electrolysis cell stack or a fuel cell stack, has an underside, an upper side and at least one end face, and a strip-type seal having at least one sealing lip is integrally bondingly mounted only on the at least one end face.

### CROSS-REFERENCE TO RELATED APPLICATIONS

This application is a U.S. National Phase of PCT Appln. No. PCT/DE 2023/100523, filed Jul. 17, 2023, which claims priority to German Patent Application No. 10 2022 119 198.2, filed Aug. 1, 2022, the entire disclosures of which are incorporated by reference herein.

### TECHNICAL FIELD

The disclosure relates to a plate which is provided for use in a stack of electrochemical cells, for example fuel cells or electrolysis cells, and which interacts in a sealed manner with other components of the cell stack. Furthermore, the disclosure relates to a method for mounting a seal on such a plate for a stack of electrochemical cells.

### BACKGROUND

A sealing arrangement for fuel cells is known, for example, from DE 101 60 905 B4. The known sealing arrangement is designed for an assembly formed from two cell separator plates, with a deformable membrane electrode unit placed between the cell separation plates. The side surfaces of the membrane electrode unit are recessed relative to the side surfaces of the cell separator plates to leave a sealing gap. According to DE 101 60 905 B4, the sealing gap should be sealed in a gas-tight manner by means of an elastic sealing element. The sealing element is made of a polymer and encloses the aforementioned assembly in the manner of a circumferential sealing strip. In addition, porous, gas-permeable plates, which are part of the membrane electrode unit, are impregnated and/or coated on one or both sides with a second polymer.

Another sealed membrane electrode arrangement for a fuel cell is disclosed in EP 3 257 097 B1. In this case, it is proposed that the edge of the membrane electrode arrangement be fluidically sealed by using a frame. For this purpose, an apparatus described in EP 3 257 097 B1 comprises a reservoir of flowable sealing material. During the production of the sealed membrane electrode arrangement, the flow-processable sealing material is hardened. A thermosetting liquid injection-moldable compound is proposed as the sealing material.

A method for mounting a seal on a component of a fuel cell is also described in US 2012/0077110 A1. The described method, which comprises an injection molding process, is also said to have positive effects on the corrosion properties of fuel cell components.

### SUMMARY

The disclosure is based on the object of specifying further developed possibilities with respect to the prior art for sealing components of fuel cells, electrolysis cells, redox flow cells or other electrochemical cells, in particular with regard to aspects of manufacturing and sealing technology.

This object is achieved according to the disclosure by a plate provided for use in a stack of electrochemical cells with one or more of the features disclosed herein. The object is also achieved by a method for mounting a seal on a plate for a cell stack having one or more of the features disclosed herein. The embodiments and advantages explained below in connection with the method apply, mutatis mutandis, to the apparatus, i.e., the plate provided for sealed installation in a cell stack, and vice versa.

In addition to the types of electrochemical cells already mentioned, so-called electrochemical hydrogen compressors, for example, are also suitable for the installation of sealed plates in accordance with the application. In connection with electrochemical hydrogen compressors, reference is made to document US 2004/0211679 A1 as an example.

The plate according to the application can, for example, be made of metal, in particular steel, plastic or a mix of materials. In the case of a metallic plate, it can in particular be a punched or laser-cut sheet. Likewise, porous, for example sintered, flat components are subsumed under the general term plate. In electrochemical cells, such plates are present, for example, in the form of porous transport layers (PTL) and gas diffusion layers (GDL). These can be single-or multi-layer fabric plates, foam-like plates or other porous plate-like structures.

In any case, the plate has two sides, which, without loss of generality, are referred to as the upper side and underside, although the terms front side and rear side would also be appropriate. Between the upper side and the underside of the plate, narrow end faces are formed at least at the outer edge of the plate, and possibly also at openings disposed in the plate. At least on one of these end faces, and indeed only on at least one of the end faces, a strip-type seal with at least one sealing lip is integrally mounted. This seal generally serves to seal the plate against at least one other component that is also installed in the cell stack.

According to various possible embodiments, the seal only contacts the end face or contoured regions of the end face. In the latter case, the contoured surfaces on the end face which are contacted by the seal are typically narrower than the wall thickness of the plate contacted by the seal. In the simplest case, the width of the end face or contoured front face is identical to the wall thickness of the plate. In variants in which a contoured end face is formed with steps to the upper side and/or underside of the plate, with the seal extending to these steps, the seal only contacts regions of the plate between the upper side and the underside of the plate. Variants are also conceivable in which the seal engages in at least one groove running parallel to the end face or individual depressions in the end face of the plate so as to provide a form-fitting connection.

In all cases, the plate can be constructed in one or more layers. A multilayer structure of the plate is particularly suitable if the plate is designed as a bipolar plate of a fuel cell or other electrochemical cell. In this case, coolant channels can be formed, for example, between two half-sheets from which the bipolar plate is constructed, with the coolant channels-in a plan view of the plate-being spaced apart from the seal. The seal, which is held at least form-fittingly on the plate, engages at the edge of the plate in a clamp-like manner around both half-sheets from which the plate, i.e., the bipolar plate, is constructed.

In variants, for example, the seal has a completely or at least approximately circular cross-sectional shape. This creates a sealing lip. Different shapes of the seal, for example with a rectangular basic shape or with one or more molded sealing lips, are also possible. In particular, the seal can be designed as a flat or shaped seal which lies substantially in the same plane as the plate on which the seal is mounted. Such a flat seal can have two or more thickened portions as sealing lips, which are connected to each other by a bridge or a plurality of bridges. The individual thickened portions have, for example, a circular, oval or polygonal cross-sectional shape.

In all variants of the method for mounting the seal on the plate, the seal is integrally fastened to one end face of the plate, optionally producing an additional form-fitting connection. The seal can be mounted using auxiliary materials such as adhesion promoters. When selecting such auxiliary materials, care must be taken to ensure that the corresponding substances cannot be dissolved or washed out during subsequent operation of the electrochemical cell, which could impair operation at another location in the cell stack.

In any case, the plate including the molded seal can be provided as a prefabricated intermediate product for the further production of the cell stack. This eliminates the step of mounting a seal during assembly, which not only streamlines the process but also increases process reliability. Among other things, there is no longer any need to check the correct position of the seal when assembling the cell stack. A wide variety of known materials, especially elastomers, are suitable for producing the seal. In any case, the material of the seal differs from the material from which the rest of the plate is made.

The seal can be molded onto the plate in particular by injection molding, i.e., in particular plastic injection molding. It is also possible to mount different seals made of different materials on one and the same plate.

In an advantageous process, the end face of the plate is roughened before the seal is molded on in order to create particularly good conditions for permanently stable retainment of the seal on the plate. The roughening of the end face can be carried out in particular by particle blasting, for example with a metallic blasting abrasive. It is also possible to roughen the end face by etching, brushing or other chemical or physical pretreatment.

Instead of molding the seal on, it is also possible to adhesively bond a prefabricated seal to the end face of the plate. Likewise, known additive processes, i.e., 3D-printing processes, can be used to directly build up the seal on at least one end face of the plate.

### BRIEF DESCRIPTION OF THE DRAWINGS

Several exemplary embodiments of the disclosure are explained in more detail below by means of drawings. In the drawings, in a partially oversimplified manner:

FIG. 1 schematically shows a stack of electrochemical cells, namely electrolysis cells;

FIG. 2 shows a plate of the cell stack according to FIG. 1;

FIG. 3 shows a plate, designed as a plastic insert, for a stack of electrochemical cells;

FIGS. 4 and 5 show different design options for plates with a seal mounted on the end face;

FIG. 6 shows a symbolic representation of steps of a method for mounting a seal on a plate provided for use in a cell stack; and

FIGS. 7 to 9 show further design options for plates with a seal mounted on an end face, in these cases in the form of a flat seal.

### DETAILED DESCRIPTION

Unless otherwise stated, the following explanations relate to all the exemplary embodiments. Parts that correspond to each other or have basically the same effect are denoted with the same reference signs in all the figures.

In the exemplary embodiments, a stack of electrochemical cells, denoted overall with the reference sign 1, is a cell stack of an electrolysis plant for producing hydrogen from water. Alternatively, the cell stack 1 could be a fuel cell stack, for example. With regard to the basic structure of the stack 1 of electrochemical cells, reference is made to the cited prior art.

The cell stack 1 comprises, among other things, plates 2 designed as bipolar plates, which separate a first electrochemical cell 3 from a further electrochemical cell 3. Each electrochemical cell 3, i.e., electrolysis cell or fuel cell, is constructed from two half-cells 4, 5, between which a membrane 6 is arranged. Instead of a membrane 6, a diaphragm could also be arranged at the corresponding position.

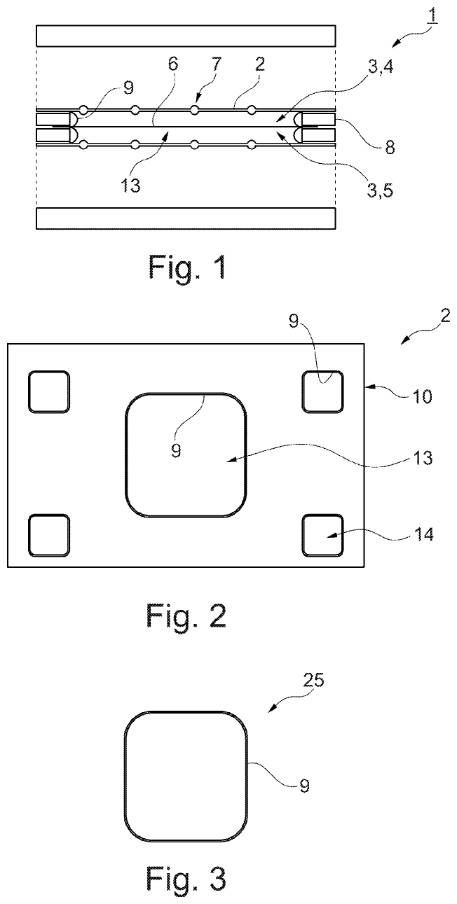

In the present cases, the bipolar plates 2 have an embossed structure denoted with 7, which is indicated by way of example in FIG. 1. Alternatively, bipolar plates without an embossed structure, i.e., flat plates without shaped elements, can be used. Furthermore, frames 8 can be seen in FIG. 1, which are placed between bipolar plates 2 arranged parallel to each other and are also generally referred to as plates.

Seals 9 are mounted on the end faces of the various plates 2, 8 made of metal, in particular stainless steel or titanium, or plastic. The end faces of the plates 2, 8, denoted generally with 10, establish the connection between an upper side 11 and an underside 12 of the plate 2, 8, and the use of the terms “upper side” and “underside” does not imply any statement about the actual orientation of the plate 2, 8 in space.

In the exemplary embodiments, the plates 2 (FIGS. 1, 2, 4, 5 and 6) are metal plates, the frames 8 of the cell stack 1 also being predominantly made of metal. Alternatively, the frames 8 could be designed as plastic components. A plastic insert 25, which is outlined in FIG. 3 and in this case has a rectangular basic shape, also constitutes a plate provided for installation in the cell stack 1. As can be seen from the drawings, seals 9 can be arranged either on the outer edge of a plate 2, 8, 25 or on the edge of recesses 13, 14 which are disposed in a plate 2, 8, 25.

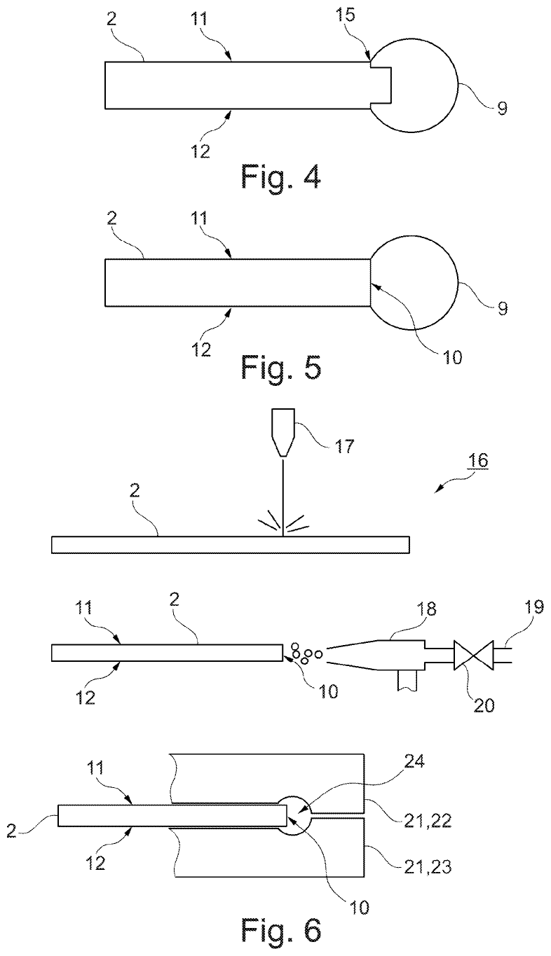

FIGS. 4 and 5 show different design options for seals 9, each of which covers an end face 10 of a plate 2. In the case of FIG. 4, the plate 2 is contoured on the end face 10 so that a step 15 is formed towards the upper side 11 as well as towards the underside 12. The seal 9 has a circular basic shape in cross-section, as shown in FIG. 4, i.e., the shape of an O-ring seal, and extends over the steps 15, but does not contact the upper side 11 and the underside 12 beyond the wall thickness of the plate 2. This means that the plate 2 slightly penetrates the seal 9 at the end face.

In contrast to this, in the design according to FIG. 5, the plate 2 has no contouring on the end face, the seal 9 only touching the end face 10 according to the wall thickness and is held there integrally. In both the variant according to FIG. 4 and the variant according to FIG. 5, the diameter of the seal 9 is significantly larger than the wall thickness of the plate 2 due to the spherical cross-sectional shape.

FIG. 6 illustrates a method for mounting the seal 9 according to FIG. 4 on the plate 2. The production plant used for this purpose is denoted generally with 16. In a first step, the plate 2 is cut with the aid of a laser 17 so as to produce the end face 10. The end face 10 is then roughened with a particle blasting device 18. The particle blasting device 18 emits, for example, metallic particles, in particular in the form of steel balls, and comprises, among other things, a compressed-air supply 19 and a shut-off valve 20.

After roughening the end face 10, the plate 2 is inserted into an injection molding tool 21, which comprises tool parts 22, 23. The tool parts 22, 23 form a cavity 24, the shape of which determines the shape of the seal 9 to be molded, which can be seen in FIG. 4. After the plate 2 together with the seal 9 has been removed from the injection molding tool 21, the plate 2 can be installed in the cell stack 1, i.e., in the electrolysis system in the present case.

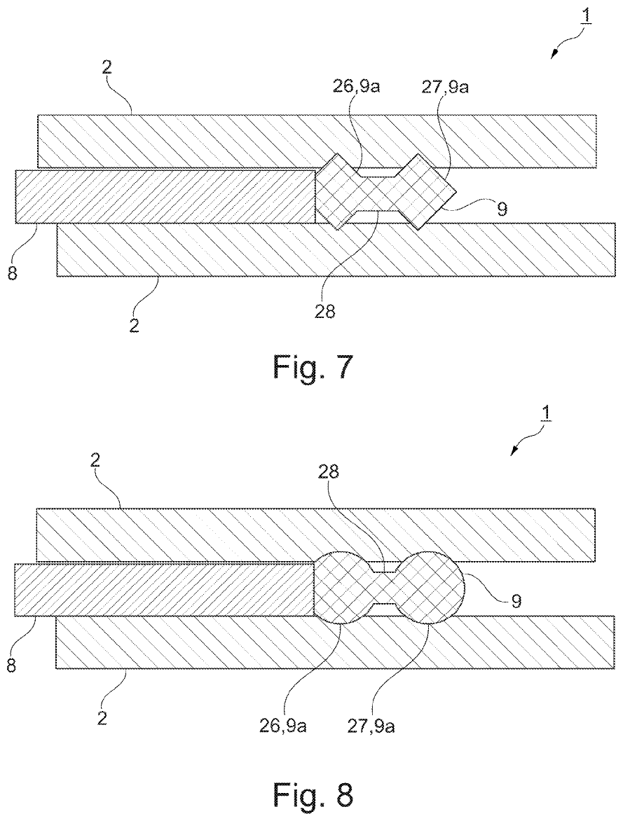

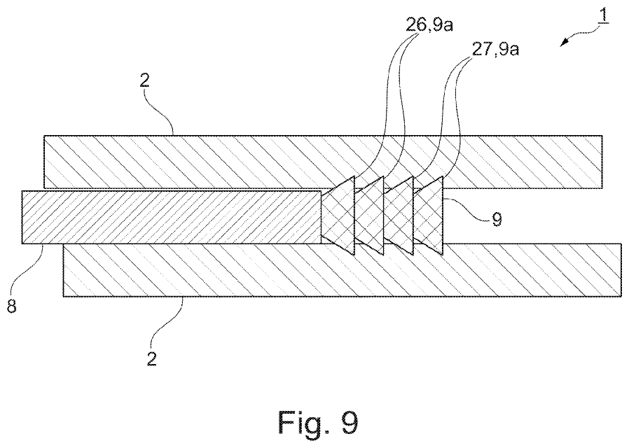

In the embodiments outlined in FIGS. 7 and 8, the seal 9 is designed as a flat seal. In each of these cases, the seal 9 has two or more thickened portions 26, 27, each of which forms a sealing lip 9a and which are connected to one another by a bridge 28. The function of sealing lips 9a is therefore realized by the thickened portions 26, 27, which in the case of FIG. 7 have a square cross-section tilted by 45 degrees with respect to the plane in which the plate 8 lies and in the case of FIG. 8 have a circular cross-section. According to FIG. 9, four frustoconical thickened portions 26, 27 are arranged next to one another and form four sealing lips 9a. Instead of the frustoconical thickened portions 26, 27, frusto-pyramidal thickened portions with a rectangular basic shape of the pyramid can also be used here. In all cases of FIG. 7 to 9, one of the thickened portions 26, 27 is integrally connected to the end face 10 of the plate 8, comparable to the embodiments according to FIGS. 1 and 5.

### LIST OF REFERENCE SIGNS

1 Stack of electrochemical cells
2 Platte, bipolar plate
3 Electrochemical cell
4 Half-cell
5 Half-cell
6 Membrane
7 Embossed structure
8 Plate, frame
9 Seal
9a Sealing lip
10 End face
11 Upper side
12 Underside
13 Recess
14 Recess
15 Step
16 Production plant
17 Laser
18 Particle blasting device
19 Compressed-air supply
20 Shut-off valve
21 Injection molding tool
22 Tool part
23 Tool part
24 Cavity
25 Plate, plastic insert
26 Thickened portion
27 Thickened portion
28 Bridge

1. A plate of a stack of electrochemical cells, the plate comprising:
an upper side, an underside and at least one end face; and
a strip-type seal having at least one sealing lip mounted integrally only on at least one of the end faces.

2. The according to claim 1, wherein the plate includes a recess having an edge, and the seal is disposed circumferentially on the edge.

3. The plate according to claim 1, wherein the plate is comprised of metal or plastic.

4. The plate according to claim 1, wherein the at least one sealing lip comprises two or more sealing lips.

5. The plate according to claim 1, wherein the seal has an at least approximately circular cross-section.

6. The plate according to claim 1, wherein the seal comprises a flat seal.

7. The plate according to claim 1, wherein the at least one end face is contoured.

8. The plate according to claim 7, wherein the seal covers a step formed on the end face towards at least one of the upper side or underside.

9. A method for mounting a seal on a plate for a stack of electrochemical cells, the method comprising: molding the seal a form-fitting manner only on at least one end face of the plate.

10. The method according to claim 9, further comprising roughening the at least one end face of the plate by particle blasting before molding on the seal.

11. The plate according to claim 1, wherein the seal comprises a shaped seal.

12. A plate of a stack of electrochemical cells, the plate comprising:
an upper side, an underside and at least one end face; and
a strip-shaped seal mounted integrally only on at least one of the end faces, the strip-shaped seal extending outwardly in an extension direction of the plate and including sealing lips that extend above and below the upper side and the underside of the plate, respectively.

13. The plate according to claim 12, wherein the strip-shaped seal has an at least approximately circular cross-section.

14. The plate according to claim 12, wherein the strip-shaped seal has at least two of the sealing lips that extend above the upper side and the underside of the plate and at least two of the sealing lips that extend below the underside of the plate.

15. The plate according to claim 14, wherein the strip-shaped seal has at least approximately circular cross-sections, and the sealing lips are formed by upper and lower surfaces of the approximately circular cross-sections.

16. The plate according to claim 14, wherein the strip-shaped seal has at least approximately square cross-sections tilted by 45 degrees, and the sealing lips are formed by upper and lower corners of the approximately square cross-sections.

17. The plate according to claim 14, wherein the strip-shaped seal has frusto-conical thickened portions, and the sealing lips are formed by upper and lower areas of the frusto-conical thickened portions.

18. The plate according to claim 12, wherein the seal covers a step formed on the end face towards at least one of the upper side or underside.
